(19) United States
(12) Patent Application Publication
(10) Pub. No.: US 2002/0178005 A1
(43) Pub. Date: Nov. 28, 2002

(54) System and method for adaptive language understanding by computers

(75) Inventors: Sorin V. Dusan, North Brunswick, NJ (US); James L. Flanagan, Warren, NJ (US)

Correspondence Address: HOFFMANN & BARON, LLP, 6900 JERICHO TURNPIKE, SYOSSET, NY, 11791, US

(73) Assignee: Rutgers, The State University of New Jersey

(21) Appl. No.: 10/123,296

(22) Filed: Apr. 16, 2002

Related U.S. Application Data
(60) Provisional application No. 60/284,188, filed on Apr. 18, 2001.
(60) Provisional application No. 60/295,878, filed on Jun. 5, 2001.

(51) Int. Cl. G10L 15/00

(52) U.S. Cl. 704/254

(57) ABSTRACT

A system and method are described for adaptive language understanding using multimodal language acquisition in human-computer interaction. Words, phrases, sentences, production rules (syntactic information) as well as their corresponding meanings (semantic information) are stored. New words, phrases, sentences, production rules and their corresponding meanings can be acquired through interaction with users, using different input modalities, such as, speech, typing, pointing, drawing and image capturing. This system therefore acquires language through a natural language and multimodal interaction with users. New language knowledge is acquired in two ways. First, by acquiring new linguistic units, i.e. words or phrases and their corresponding semantics, and second by acquiring new sentences or language rules and their corresponding computer actions. The system represents an adaptive spoken interface capable of interpreting the user's spoken commands and sensory inputs and of learning new linguistic concepts and production rules. Such a system and the underlying method can not only be used to build adaptive conversational or dialog systems, but also to build adaptive interactive computer interfaces and operating systems, expert systems and computer games.

### FIELD OF THE INVENTION

The present invention relates to the field of natural communication with information systems, and more particularly to a system and method for multimodal language acquisition in a human-computer interaction using structured representation of linguistic and semantic knowledge.

### BACKGROUND OF THE INVENTION

Natural communication is an emerging direction in human-computer interfaces. Spoken language plays a central role in allowing the human-computer communication to resemble human-human communication. A spoken language interface requires implementation of specific technologies such as automatic speech recognition, text-to-speech synthesis, dialog management and language understanding. Computers must not only recognize users' utterances, but they must also understand meanings in order to perform specific operations or to provide appropriate answers. For specific applications, computers can be programmed to recognize and understand a limited vocabulary, and execute appropriate actions related to spoken commands. A classic way of preprogramming computers to recognize and understand spoken language is to store the allowed vocabulary and sentence structures in a rule grammar. However, communicating by voice with speech-enabled computer applications based on preprogrammed rule grammars suffers from constrained vocabulary and sentence structures. Deviations from the allowed language result in an unrecognized utterance which will not be understood and processed by the system. A challenge in spoken language understanding systems is the variability of human language. Different speakers use different words and language structures to convey the same meaning. Another problem is that users may use unknown words for which the system was not preprogrammed. One way to alleviate this restriction consists in allowing the user to expand the computer's recognized and understood language by teaching the computer system new language knowledge. These problems point up the need for language acquisition during an interaction.

A definition of an automatic system capable of acquiring language was presented by Chomsky, N., Aspects of the Theory of Syntax, MIT Press, 1965, as “an input-output device that determines a generative grammar as output, given primary linguistic data (signals classified as sentences and non-sentences) as input”. A large number of studies in the area of language acquisition focused on learning the syntactic structure of language from a finite set of sentences. Other studies focused on acquiring the mapping from words, phrases or sentences to meanings or computer actions. A review paper of some studies of automatic language acquisition based on connectionist approaches was published by Gorin, A., On automated language acquisition, J. Acoust. Soc. Am. 97(6), 1995, 3441-3461. Also, a U.S. Pat. No. 5,860,063 to Gorin et al. discloses a system and method for automated task selection where a selected task is identified from the natural speech of the user making the selection. In general, those systems do not acquire new semantics. They acquire only new words or phrases and their semantic associations with existing, preprogrammed actions or meanings.

A study focusing on the acquisition of linguistic units and their primitive semantics from raw sensory data was published by Roy, D. K., Learning Words from Sights and Sounds: A Computational Model, Ph.D. Thesis, MIT, 1999. That system had to discover not only the semantic representation from the raw data coming from a video camera, but also the new words from the raw acoustic data provided by a microphone. A mutual information measure was used in that study to represent the word-meaning correlates. Another study of discovering useful linguistic-semantic structures from sensory data was published by Oates, T., Grounding Knowledge in Sensors: Unsupervised Learning for Language and Planning, Ph.D. Thesis, MIT, 2001. This author used a probabilistic approach in an unsupervised method of learning for language and planning. The goal was to enable a robot to discover useful word-meaning structures and action-effect structures. A study of acquiring new words and grammar rules by a computer using the typing modality was published by Gavalda, M. and Waibel, A., Growing Semantic Grammars, in Proceedings of COLING/ACL-98, 1998. However, that study did not approach the acquisition of new semantics. Very few studies focused on acquiring knowledge at both syntactic and semantic levels of a language. Although in learning theories, as presented by Osherson et. al., Systems That Learn. An Introduction to Learning Theory for Cognitive and Computer Scientists, MIT Press, 1986, the language acquisition may be considered as the acquisition of a grammar alone that is sufficient to accommodate new linguistic inputs, a computer system needs more than a grammar in order to interpret, process and respond to the spoken language. It needs also semantic representations of these words and phrases. Thus, the computer system must be able to acquire from users words, phrases and sentences and their corresponding semantic representations.

As discussed above, the prior art method is that in which the computer system itself discovers the patterns of the new words, the new semantics and the connections between them. This method is less accurate and very slow. Therefore, a need exists for a more accurate and faster system and method for learning structured knowledge using multimodal language acquisition in human-computer interaction at both syntactic and semantic level, in which the user teaches the computer system, new words, sentences and their corresponding semantics.

### SUMMARY OF THE INVENTION

The present invention provides a system and method for adaptive language understanding using multimodal language acquisition in human-computer interaction. Utterances spoken by the user are converted into text strings by an automatic speech recognition engine in two stages. If the utterances matches those allowed by the system's rule grammar, the corresponding text strings are processed by a language understanding module. If the utterances contain unknown words or sentence structures, the corresponding text strings are processed by a new-word detector which extracts the unknown words or language structure and asks the user for their meanings or computer actions. The semantic representations can be provided by users through multiple input modalities, including speaking, typing, drawing, pointing or image capturing. Using this information the computer creates semantic objects which store the corresponding meanings. After receiving the semantic representations from the user, the new words or phrases are entered into the rule grammar and the semantic objects are stored in the semantic database. Another means of teaching the computers new vocabulary and grammar is by typing on a keyboard.

### BRIEF DESCRIPTION OF THE DRAWINGS

FIG. 1 is a block diagram of the adaptive language understanding computer system.

FIG. 2 is an illustration of a schematic two-dimensional representation of structured concepts.

### DETAILED DESCRIPTION OF THE PREFERRED EMBODIMENT

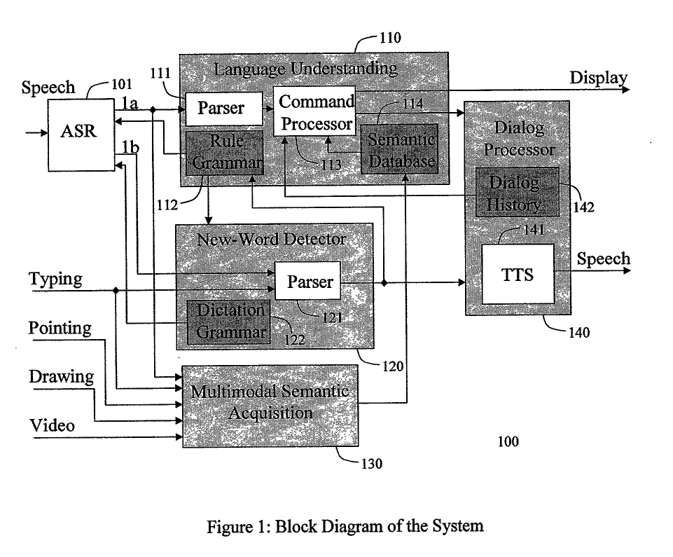

With reference to FIG. 1 is shown a block diagram of a system. A preferred hardware architecture of the system is that of a conventional personal computer, running one of the Windows operating systems. The computer is equipped with multimodal input/output devices, such as, microphone, keyboard, mouse, pen tablet, video camera, display and loudspeakers. All these devices are well-known in the art and therefore are not diagrammed in FIG. 1. However, the action taken by the user utilizing these devices are illustrated in FIG. 1 as “speech”, “typing”, “pointing”, “drawing” and “video”. The software architecture of the system 100 includes five main modules: an automatic speech recognition (ASR) engine 101, a language understanding module 110, a new-word detector 120, a multimodal semantic acquisition module 130, and a dialogue processor module 140. The software is preferably implemented in Java. The “Via Voice” commercial speech recognition and synthesis package made by IBM is preferably utilized in the present invention.

The ASR 101 transforms the spoken utterances of the user into text strings in two different stages. First, if the utterance matches one of the utterances allowed by the rule grammar 112, then the ASR 101 provides a text string at output 1a. Second, if the utterance does not match any of the utterances allowed by the rule grammar, then a text string corresponding to this utterance is provided by the ASR 101 at output 1b.

The language understanding module 110 processes the allowed spoken utterances and comprises a parser 111, a rule grammar 112, a command processor 113 and a semantic database 114. The function of each will be described in detail. The language understanding module 110 receives from the ASR 101 at the output 1a, a text string corresponding to one of the allowed utterances permitted by the rule grammar 112. This text string also includes tags specified in the rule grammar and it is forwarded to the parser 111 which parses the text for semantic interpretation of the corresponding utterance. The tags are used by the parser for semantic interpretation. Rule grammar 112 not only stores the allowed words and sentences, but also the language production rules. During parsing, the tags are identified and the parser asks the command processor 113 to execute specific computer actions or to trigger some answers by the dialog processor 140 to be converted into synthetic speech. The command processor 113 uses information from the semantic database 114 and from dialog history 142 in order to execute appropriate computer actions. Dialog processor 140 comprises of a text-to-speech converter (TTS) 141 which converts a text into a synthetic voice message and a dialog history 142 which stores the last recognized utterances for contextual inference.

Rule grammar 112 is preprogrammed by the developer and can be expanded by users. This rule grammar 112 contains the allowed sentences and vocabulary that can be recognized and understood by the system. After an utterance has been spoken by the user, the ASR 101 first runs with a language model derived from the rule grammar 112. Thus the production rules from the rule grammar constrain the recognition process in the first stage. The rule grammar 112 is a context-free semantic grammar and contains a finite set of non-terminal symbols, which represent semantic concept classes, a finite set of terminal symbols disjoint from non-terminal symbols, corresponding to the vocabulary of understood words, a start non-terminal symbol and a finite set of production rules. The rule grammar 112 can be expanded by acquiring new words, phrases, sentences and rules from users using the speech and typing input modalities. The rule grammar 112 is dynamically updated with the newly acquired linguistic units. The rule grammar 112 is stored in a file on hard disk, from where it can be loaded in the computer's RAM memory.

If the utterance does not match any of the allowed utterances, the ASR 101 does not provide any text string at output 1a and switches the language model to one derived from a dictation grammar 122. A new decoding process takes place in the ASR 101 based on the new language model and the resulting text strings 1b are provided to the new-word detector module 120 which contains a parser 121 and the dictation grammar 122. The dictation grammar 122 contains a large vocabulary of words and allows the user to speak more freely as in a dictation mode. The role of this dictation grammar 122 is to provide the ASR 101 a second language model which allows the user to speak more unconstrained utterances. These unconstrained utterances are transformed by the ASR 101 into text strings at output 1b. Moreover, the dictation grammar 122 is either general purpose or domain specific and can contain up to hundreds of thousands words. Parser 121 receives the text strings from ASR 101 at output 1b and detects the words or phrases not found in the rule grammar 112 as new words. For example, if the spoken utterance is “select the pink color”, the system knows the words “select”, “the” and “color” because these words are stored in rule grammar 112. However, it does not understand the word “pink”, which is identified by parser 121 as a new word.

Upon detecting a new word or phrase the new-word detector 120 indicates the dialog processor 140 to ask the user to provide a semantic information or representation for the unknown word or phrase. For the above example, the system tells the user “I don't know what pink means”. The user can provide the meaning or semantic representation for the new linguistic unit via multiple input modalities, appropriately. The user indicates by voice what modality will be used. Such modalities used by the user may preferably include speaking into a microphone, typing on a keyboard, pointing on a display with a mouse, drawing on a pen tablet or capturing an image from a video camera. For example, the user can say “Pink is this color” and, using the mouse, point simultaneously with the cursor on the screen to the pink region on a color palette. When the meaning or semantic representation is provided by the user, the new-word detector 120 saves the new word or phrase into the rule grammar 112 in the corresponding semantic class of concepts, such as “colors” for the above example. The meaning or semantic representation of the new words is acquired by the multimodal semantic acquisition module 130 which creates appropriate semantic objects and stores them in the semantic database 114. Although, not shown in FIG. 1, at the end of each application session, the user has the possibility to save permanently the updated rule grammar 112 and semantic database 114 in the corresponding files on the hard disk. The new-word detector 120 help the user know if the utterances contain any unknown words or phrases.

Another way to teach the computer new words is by typing these words on a keyboard. The parser 121 compare these words, with those allowed by the rule grammar 112 and if they are unknown conveys the same to the user through the dialog processor 140. For example, the user can type “New Brunswick” and the computer system will respond “I don't know what New Brunswick means”. Then the user can say “New Brunswick is a city” and “New Brunswick” will be added in the rule grammar 112 in the semantic class “cities”. By typing, users can also teach the computer system new sentence or language rules and the corresponding computer actions. The new sentence or language rule will then be added to the rule grammar 112 and the corresponding computer action will be used to create a semantic object by semantic acquisition module 130, that will be stored in the semantic database 114. An example of such a new sentence is “Double the radius variable”, which is followed by the semantic description “{radius} {multiplication} {2}”. The computer action corresponding to the above command needs to be described in terms of known computer operations. An example of teaching the system a production rule derived from the above sentence is “Double the <variable> variable” followed by “<variable> {multiplication} {2}”, where the nonterminal symbol “<variable>” stands for any of the variables of the application, such as radius, width, etc.

The dialog processor module 140 represents a spoken interface with the user. The voice message, which preferably may be an answer or response to the user's question, is further transmitted to the user by the text-to-speech engine 141. The dialog history 142 is used for interpreting contextual or elliptical sentences. The dialog history 142 temporarily stores the last utterances for elliptical inference in solving ambiguities. In other words, dialog history 124 is a short-time memory of the last dialogs for obtaining the contextual information in order to process elliptical utterances. For example, the user can say “Please rotate the square 45 degrees” and then can say “Now the rectangle”. The action “rotate” is retrieved from the dialog history 142 in order to process the second utterance and rotate the rectangle 45 degrees.

In order to build computer systems capable of natural interaction with users based on natural language, the semantics of linguistic units acquired by these systems have to reflect the user's interpretation of these linguistic units. For example, in the present invention, the computer system is taught the primitive color concepts as a combination of three fundamental color intensities, red, green and blue, RGB, which the computer uses to display colors. Also, in the present invention, computer system is taught higher-level concepts, which require more human interpretation than the primitive concepts. For example, the computer system can be taught the meaning of the word “face” by drawing a graphic combination of more elementary concepts such as “eye”, “nose”, “mouth”, etc. representing a face.

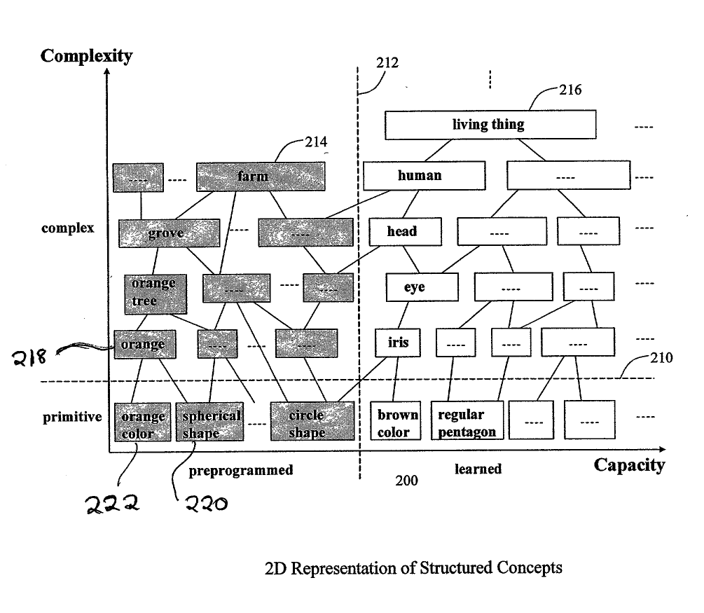

The language knowledge in the present invention is stored in two blocks: the rule grammar 112 which stores the surface linguistic information represented by the vocabulary and grammar, and the semantic database 114 which stores the semantic information of the language. The semantic objects can be built using semantic information from lower-level concepts. FIG. 2 shows a schematic two-dimensional structured knowledge representation 200 as an example of implementing structured concepts using information from lower-level concepts as presented in the method of the present invention. Each rectangle represents a concept described by an object and has a name identical with the surface linguistic representation (the word or phrase) and a corresponding semantics that can have different computer representations coming from the five input modalities—speech, typing, drawing, pointing or image capturing. The abscissa represents the increase in capacity of linguistic knowledge and the ordinate represents the level of complexity of linguistic knowledge. The horizontal dotted line 210 separates the primitive levels from the complex levels and the vertical dotted line 212 separates the preprogrammed knowledge from the learned knowledge. The gray rectangles 214 in FIG. 2 represent preprogrammed concepts and the white rectangles 216 represent knowledge learned or acquired from the user. As shown by the dots in the top-right sides of this figure, the knowledge can be expanded through learning in both complexity and capacity directions.

A fixed set of concepts, at both primitive and higher complexity levels is preprogrammed and stored permanently in the rule grammar 112 by the developer. The computer system can expand the volume of knowledge acquiring new concepts horizontally, by adding new concepts in the existing semantic classes, and vertically, by building complex concepts upon the lower-level concepts. In this structure the semantic classes correspond to the non-terminal symbols from the rule grammar 112. For example, as shown in FIG. 2, in an existing “fruits” semantic class one could teach the computer a new word, “orange” 218, that will have a semantic object derived from the primitive “spherical” shape 220 and an “orange” color 222. The new concept can be used for representing new semantic information from other primitive concepts such as colors or shapes or more complex concepts like house, which has rooms, which have doors, which have knobs, etc.

Experiments on language acquisition based on this method have been carried out using speech and typing to acquire new words, phrases and sentences. Speech, typing, pointing, drawing and image capturing have been used to acquire the corresponding semantic representations. The experimental application had a preprogrammed rule grammar, consisting of 20 non-terminal symbols, each of them containing a number of terminal symbols and 22 rules consisting of sentence templates. It is to be understood that the present invention is not restricted to a specific number of non-terminal symbols and rules in the rule grammar. Some of the examples of the experiments are described in detail below.

One example is acquiring primitive language concepts such as colors. The user can ask the computer system to select an unknown color for drawing using different sentences, such as “Can you select the burgundy color?” or “Select burgundy”. Because this color was not preprogrammed by the developer, the computer system will detect the word “burgundy” as unknown and let the user know that it is expecting a semantic representation for this new word, by responding “I don't know what burgundy means”. If the user wants to teach the computer system this word and its meaning, he or she can ask the computer to display a rainbow of colors or a color palette and then point with the mouse to the region that represents the burgundy color according to his or her knowledge. The user can say, for example, “Burgundy means this color” and point the mouse to the corresponding region from the rainbow. Then the computer system interprets the speech and pointing inputs from the user and creates new concept “burgundy” in the non-terminal class “colors” of the rule grammar. The computer system identifies the red-green-blue (RGB) color code of the point on the rainbow corresponding to cursor position when the user said “this”. A similar acquisition can be performed using the images from the video camera.

Another example is acquiring a new phrase using only the speech modality. The computer system was preprogrammed with the knowledge corresponding to the concept “polygon”. If the user says “Please create a pentagon here” pointing with the mouse on the screen, the computer system responds “I don't know what is a pentagon”. Then the user can say, for example “A pentagon is a polygon with five sides”, and the computer system creates a new terminal symbol “pentagon” in the non-terminal class “polygon” and a new object called “pentagon” inherited from “polygon” and having the number of sides attribute equal to five.

Another example, in which the computer system acquires a complex concept, is the following. To teach the computer system the concept ‘house’ the user can draw on the screen using the mouse or the pen and pen tablet a house consisting of different parts. Each part of the complex object has to be taught first as an independent concept and stored in the rule grammar 112 and semantic database 114. Then, the user can display on the screen a combination of these objects that can be taught to the computer system as ‘house’. The word “house” will be added in the rule grammar 112 under a class “drawings” and a semantic object containing all the names and properties of the components of the house will be stored in the semantic database 114.

An example of acquiring a new sentence using the typing modality alone is now described. The computer system was preprogrammed with knowledge about the elementary arithmetic operations: addition, subtraction, multiplication and division. These words were also present in a non-terminal symbol called “arithmetic operation” in the rule grammar 112. Also, the computer system knew the concepts of some variables used for graphical drawing, such as current color, radius of regular 2D figures, etc., which have some default values. Then the user can teach the computer system by typing a new sentence, such as “Double the radius”. The meaning of this new sentence can be further typed as “ {radius} {multiplication}{2}. The computer system creates an object “double” which performs the multiplication by 2.

An example of teaching the computer system a new production rule is a generalization of the previous example. The user can type “Increment the <variable>; <variable> {addition} {1}”. Here, the angle brackets are used to specify a non-terminal symbol. The interpretation of this text input is similar to that from the previous example.

In these experiments the rate of acquiring new language and the corresponding semantics is relatively high. It takes only a few seconds to teach the computer system new words and meanings using the speech modality alone. When other input modalities are used to represent the semantics, the acquisition time is longer, depending on the complexity of the new concept, e.g., a drawing made by using the pen tablet.

While the invention has been described in relation to the preferred embodiments with several examples, it will be understood by those skilled in the art that various changes may be made without deviating from the spirit and scope of the invention as defined in the appended claims.

What is claimed is:

1. A method for adaptive language understanding using multimodal language acquisition, comprising the steps of:
receiving from a user one or more spoken utterances comprising at least one word;
identifying whether said utterance comprises unknown words not included in a database;
requesting the user to provide semantic information for said identified unknown words;
storing the identified unknown word and creating and storing a new semantic object corresponding to the identified unknown word based on the semantic information received from the user through one or more input modalities.

2. The method of claim 1 wherein said utterance comprise a phrase.

3. The method of claim 1, further comprising converting the spoken utterances included in the database into text strings of words.

4. The method of claim 3, further comprising parsing the text strings and performing a semantic interpretation of said spoken utterance included in the database.

5. A method of claim 4, wherein said database is a rule grammar and the semantic interpretation of said spoken utterance is performed based on information stored in a semantic database.

6. The method of claim 3, wherein the said database comprises allowed words, sentences and production rules.

7. The method of claim 6, further comprising comparing the words of the converted text strings from the spoken utterance with the allowed words in the database.

8. The method of claim 6, further comprising identifying the spoken utterance as the unrecognized spoken utterance if the spoken utterance did not match any of the allowed sentences in the database.

9. The method of claim 8, further comprising the converting of the unrecognized spoken utterance into text strings using a dictation grammar and parsing the converted text strings corresponding to the unrecognized spoken utterances not stored in the database.

10. The method of claim 9, wherein the dictation grammar comprises a vocabulary of words and allows unconstrained utterances.

11. The method of claim 1, further comprising receiving from the user a typed text message including a new sentence or production rule to be recognized along with the corresponding semantics and computer action.

12. The method of claim 1, further comprising indicating to the user via speech to provide the semantic information for the said identified unknown words.

13. The method of claim 1, further comprising storing the identified unknown words into the database after receiving from the user semantic information for the identified unknown words.

14. The method of claim 2, wherein the database represents a context-free grammar organized as a semantic grammar having non-terminal symbols representing semantic classes of concepts.

15. The method of claim 14, wherein the user specifies by voice the concept class from the database to which the identified unknown word or phrase is added after receiving its semantic representation.

16. The method of claim 1, wherein the database is dynamically updated with the new words or phrases after receiving their semantic representation.

17. The method of claim 16, wherein the dynamically updated database can be saved permanently in a file on a hard disk.

18. The method of claim 2, wherein the semantic information of the identified unknown word or phrase is received via devices selected from a group consisting of microphone, keyboard, mouse, pen tablet or video camera, and combinations thereof.

19. The method of claim 18, wherein the user indicates by voice the device that will be used for providing the semantic information for the identified unknown word or phrase.

20. The method of claim 1, further comprising searching for identified unknown words using a parser and comparing each word with all the known words stored in the database.

21. The method of claim 5, wherein the semantic information of the identified unknown word or phrase and the corresponding semantic object are stored in the rule grammar and the semantic database, respectively.

22. An adaptive language understanding computer system comprising:
a) an automatic speech recognition engine for converting spoken utterances into text strings
b) a language understanding module for at least processing spoken utterances having:
i) a rule grammar for storing allowed vocabulary of words, sentences and production rules recognized and understood by the system;
ii) a semantic database for storing semantic objects describing semantic representations of the words; and
iii) a first parser for identifying the semantic interpretation of the recognized and understood spoken utterances;
iv) a command processor for executing appropriate commands or computer actions.
c) a new-word detector module for at least processing spoken utterances not allowed by the rule grammar, having:
i) a dictation grammar for storing a vocabulary of words and allowing the speech recognizer to recognize the spoken utterances if the spoken utterances are not allowed in the rule grammar; and
ii) a second parser for identifying words in the spoken utterances not found in the rule grammar as unknown words;
d) a multimodal semantic acquisition module responsive to an input of semantics for the identified unknown words by creating and storing in the semantic database new semantic objects corresponding to the identified unknown words;
e) a dialog processor module for communicating by synthetic voice with the user;
f) one or more input devices selected from a group consisting of microphone, keyboard, mouse, pen tablet and computer video camera, and combinations thereof.

23. The adaptive language understanding computer system of claim 22, wherein the automatic speech recognizer converts the spoken utterances into text strings using a language model derived from the rule grammar, if the spoken utterance is allowed in the rule grammar.

24. The adaptive language understanding computer system of claim 22, wherein the automatic speech recognizer converts the spoken utterances into text strings using a language model derived from the dictation grammar if the spoken utterance is not allowed in the rule grammar.

25. The adaptive language understanding computer system of claim 22, wherein the dialog processor module comprises text-to-speech converter for converting the text strings into voice messages and forwarding these messages to the user.

26. The adaptive language understanding computer system of claim 22, wherein the dialog processor module comprises a dialog history for temporarily storing the last spoken utterances for elliptical inference in solving ambiguities.

27. The adaptive language understanding computer system of claim 22, wherein the rule grammar database is permanently stored in a file on a hard disk from where it is loaded into a RAM computer memory.

28. The adaptive language understanding computer system of claim 27, wherein the semantic database is permanently stored in a file on the hard disk from where it is loaded into the RAM computer memory.

29. The adaptive language understanding computer system of claim 22, wherein the user indicates by voice the input device that will be used to provide the semantics of the identified unknown words.

30. The adaptive language understanding computer system of claim 22, wherein the identified unknown words are understood by the system after their semantics have been provided by the user.

31. The adaptive language understanding computer system of claim 22, wherein a new sentence or production rule typed by the user along with the corresponding semantics and computer action is acquired and stored in the rule grammar and the semantic database, respectively.
